(19) United States
(12) Patent Application Publication
(10) Pub. No.: US 2011/0215987 A1
(43) Pub. Date: Sep. 8, 2011

(54) ANTENNA DEVICE

(75) Inventors: MASAHIRO OHARA, Fukui (JP); TORU ARAKAWA, Fukui (JP); HIROTAKA ISHIHARA, Osaka (JP); KENJI NAKASONO, Fukui (JP)

(73) Assignee: PANASONIC CORPORATION, Osaka (JP)

(21) Appl. No.: 13/035,401

(22) Filed: Feb. 25, 2011

(30) Foreign Application Priority Data
Mar. 2, 2010 (JP) 2010-045149
Jan. 7, 2011 (JP) 2011-001742

(51) Int. Cl. H01Q 1/50

(52) U.S. Cl. 343/906

(57) ABSTRACT

An antenna device includes an antenna, a case accommodating the antenna therein, a sealing cap partially inserted into the case, and a connection terminal extending from the antenna in a predetermined direction. The sealing cap includes an insert portion inserted into the case, and a connector portion exposed from the case. The minimum width of the case in a direction perpendicular to the predetermined direction is smaller than the minimum width of the connector portion in a direction perpendicular to the predetermined direction. This antenna device is flexibly adaptable to a change of a vehicle connector which is inserted into the device, while maintaining a compact size.

### FIELD OF THE INVENTION

The present invention relates to an antenna device having a small size.

### BACKGROUND OF THE INVENTION

In recent years, a vehicle remotely locking or unlocking a door through an antenna device installed in the vehicle is increasing in number, and requires the antenna device to have a small size.

FIGS. 9 and 10 are a cross sectional view and an exploded perspective view of a conventional antenna device 20, respectively. Coil 2 which is a metal wire, such as an enameled wire, is wound about magnetic body 1 made of magnetic material, such as ferrite.

Magnetic body 1 is inserted into recess 3A at a right side of terminal base 3 of insulating resin to be held inside the case. Magnetic body 1, coil 2, and terminal base 3 constitute antenna 10. Antenna 10 is inserted into hollow case 11 through opening 11A. Case 11 has a rectangular parallelepiped shape with a closed right side.

Two connection terminals 12 made of a conductive metal and having a plate shape extend from a left side of terminal base 3. Waterproof ring 13 made of rubber having a ring shape is fit into step portion 3B provided at a left side of outer periphery of terminal base 3. Connection terminal 12 extends and is inserted through waterproof ring 13. Connector 14 having a tubular shape is inserted into case 11 from a left side of case 11, thus constituting antenna device 20.

By inserting connector 14 into case 11 where antenna 10 is already inserted, antenna 10 and connector 14 are manufactured into one piece, providing antenna device 20 with a small size.

An outside peripheral surface of water proof ring 13 contacts case 11. An inside and a right side peripheral surface of ring 13 contact terminal base 3. A left side peripheral surface of ring 13 contacts connector 14. This structure prevents water or moisture from entering into an inside circumference of connector 14 and into a right side of terminal base 3 through an outside circumference of connector 14.

Thus structured antenna device 20 is installed inside a vehicle door handle, for instance, and the device is connected to a controller installed in an instrument panel of the vehicle.

The vehicle connector attached to an end of a cable extending from the controller is inserted into connector 14 of antenna device 20, thereby connecting the controller and antenna device 20.

The vehicle connector provided at an extension of the controller is pushed into antenna device 20 through an inside of connector 14 until a front end contacts a left side of terminal base 3 beyond opening part 11A.

When a driver with a mobile transmitter-receiver approaches a vehicle, the transmitter-receiver and antenna device 20 start communication. Then, the controller unlocks the door of the vehicle, or locks the door when the driver leaves.

In conventional antenna device 20, the vehicle connector extending from the controller is inserted into connector 14 through opening 11A. The size of an inner circumference of case 11 restricts the size of the vehicle connector adaptable to the device, thus preventing a larger size vehicle connector from being inserted.

That is, connector 14 to adapt such a large size vehicle connector, case 11 and terminal base 3 have to have a different shape for each vehicle connector, hence preventing antenna device 20 from employing common components.

An antenna device similar to conventional antenna device 20 is disclosed in Japanese Patent Unexamined Publication No. 2008-042237.

### SUMMARY OF THE INVENTION

An antenna device includes an antenna, a case accommodating the antenna therein, a sealing cap partially inserted into the case, and a connection terminal extending from the antenna in a predetermined direction. The sealing cap includes an insert portion inserted into the case, and a connector portion exposed from the case. The minimum width of the case in a direction perpendicular to the predetermined direction is smaller than the minimum width of the connector portion in a direction perpendicular to the predetermined direction.

This antenna device is flexibly adaptable to a change of a vehicle connector which is inserted into the device, while maintaining a compact size.

### BRIEF DESCRIPTION OF THE DRAWINGS

FIG. 1 is a cross sectional view of an antenna device according to Exemplary Embodiment 1 of the present invention.

FIG. 2 is an exploded perspective view of the antenna device according to Embodiment 1.

FIG. 3 is an enlarged sectional view of a main part of the antenna device according to Embodiment 1.

FIG. 4 is a top view of another antenna device according to Embodiment 1 in which an antenna and a sealing cap are combined.

FIG. 5 is an exploded perspective view of an antenna device according to Exemplary Embodiment 2 of the invention.

FIG. 6 is a cross sectional view of the antenna device according to Embodiment 2.

FIG. 7 is an enlarged sectional view of the antenna device according to Embodiment 2.

FIG. 8 is a top view of another antenna device according to Embodiment 2.

FIG. 9 is a cross sectional view of a conventional antenna device.

FIG. 10 is an exploded perspective view of the conventional antenna device.

### DETAILED DESCRIPTION OF PREFERRED EMBODIMENTS

### Exemplary Embodiment 1

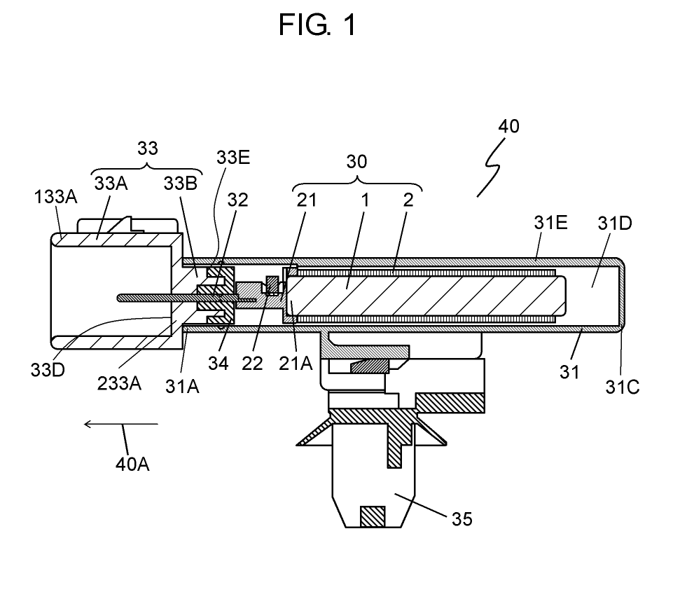

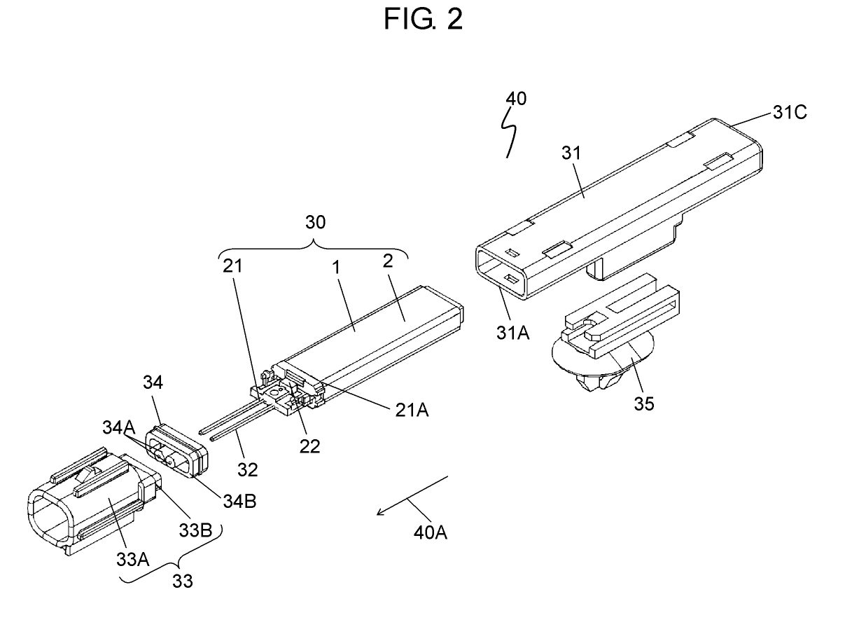

FIGS. 1 and 2 are a cross sectional view and an exploded perspective view of an antenna device 40 according to preferred embodiment 1 of the invention, respectively. Coil 2 made of a metal wire, such as an enameled wire, is would about magnetic body 1 made of magnetic material, such as ferrite. Magnetic body 1 is fixed to terminal base 21 made of insulating resin, constituting antenna 30.

Hollow case 31 includes sleeve 31E extending in predetermined direction 40A, closed end 31C, and opening 31A opening in predetermined direction 40A opposite to end 31C. Case 31 has a rectangular parallelepiped shape, and has cavity 31D facing opening 31A. Antenna 30 is inserted into cavity 31D of case 31 through opening 31A. Two connection terminals 32 made of a conductive metal and having a plate shape extend from antenna 30 in predetermined direction 40A. Connection terminals 32 are inserted into sealing cap 33 and elastic sealer 34 which has a substantially essentially rectangular parallelepiped shape. Sealing cap 33 and elastic sealer 34 both seal opening 31A of case 31. Engaging fixture 35 is engaged with a lower surface of case 31 for fixing the device to an on-board device of a vehicle for instance, thus constituting antenna device 40.

Recess 21A is formed in a right side of terminal base 21. Magnetic body 1 is inserted into recess 21A to be held there. A chip capacitor 22 is mounted onto an upper surface of terminal base 21. Capacitor 22 is electrically connected to coil 2, forming a series resonant circuit. Connection terminal 32 is fixed to terminal base 21 by an insert molding, for instance. Two connection terminals 32 function as both ends of the series resonant circuit formed by capacitor 22 and coil 2, and extend from a left side of terminal base 21 in predetermined direction 40A.

The insert molding is a method of unitarily forming a resin and a metal part, such as connection terminal 32 and terminal base 21, by injecting the resin around the metal parts.

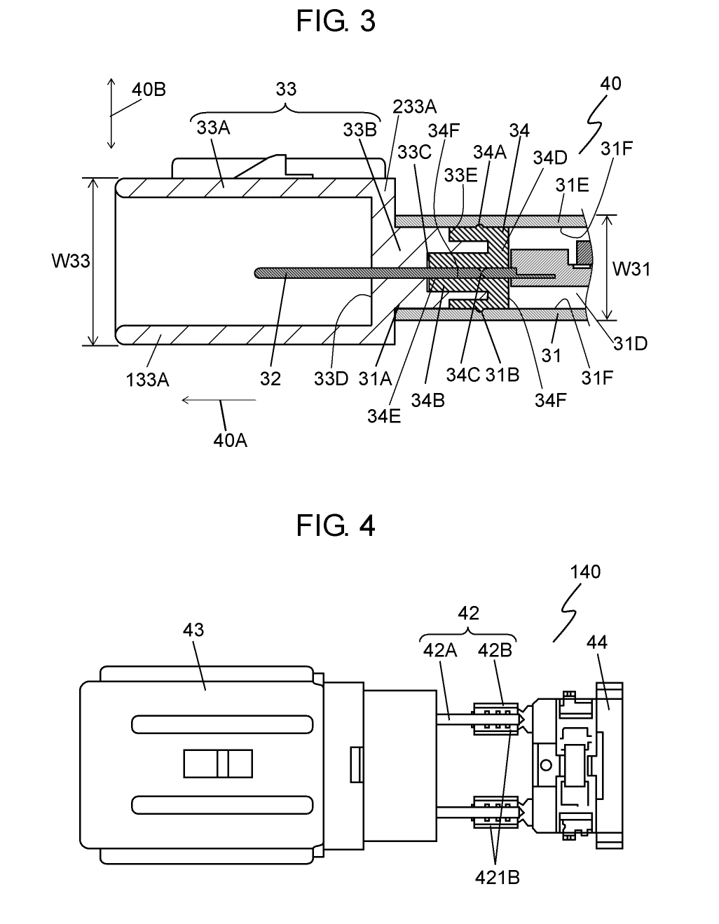

FIG. 3 is an enlarged sectional view of a main part of antenna device 40. Opening 31A of case 31 has a substantially rectangular shape viewed from direction 40A (see FIG. 2). Sleeve 31E has inside wall 31F facing cavity 31D. Groove 31B is formed in inside wall 31F at a position slightly inside opening 31A. Groove 31B rounds along inside wall 31F. Antenna 30 is located between groove 31B and end 31C.

Sealing cap 33 is made of insulating resin, such as ABS resin. The sealing cap has connector portion 33A having a tubular shape and insert portion 33B having a substantially rectangular parallelepiped shape. Connector portion 33A has sleeve 133A extending in direction 40A and bottom 233A. Bottom 233A has surface 33D which is as inner bottom surface. Sleeve 133A surrounds connection terminal 32. Bottom 233A closes sleeve 133A. In the embodiment, sleeve 133A has a substantially circular cylindrical shape. Insert portion 33B has surface 33E located in cavity 31D and facing cavity 31D. Surface 33E of connector portion 33A is located opposite to surface 33D of connector portion 33A. Insertion hole 33C passes from surface 33E of insert portion 33B through connector portion 33A, and has an inner diameter narrowed by a step from surface 33E.

Elastic sealer 34 is made of elastic material, such as rubber. Elastic sealer 34 includes main body 34D sealing cavity 31D of case 31, protrusion 34A protruding from an outer circumference of main body 34D, and two terminal insertion portions 34B extending toward sealing cap 33. Protrusion 34A rounds around the outer circumference of main body 34D. Terminal insertion portion 34B has a cylindrical shape and has through-hole 34E therein. Terminal insertion portion 34B has inner wall 34F facing through-hole 34E and bump 34C protruding from inner wall 34F toward through-hole 34E.

Terminal insertion portion 34B is inserted from a right side of sealing cap 33 into insertion hole 33C to fix elastic sealer 34 to sealing cap 33. Connection terminal 32 is inserted into through-hole 34E of terminal insertion portion 34B, and is pressed by bump 34C inside through-hole 34E.

Insert portion 33B of sealing cap 33 is entirely accommodated in cavity 31D of case 31. A right surface of elastic sealer 34 faces a left side of terminal base 21, and protrusion 34A is engaged with groove 31B, fixing the position of sealing cap 33.

An end of connection terminal 32 extends from surface 33D of sealing cap 33 which is an inner bottom surface of sealing cap 33. Inner bottom surface 33D is at a left side of opening 31A of case 31 or at an outside of cavity 31D of case 31 not in cavity 31D.

Minimum width W31 in direction 40B perpendicular to direction 40A is a width of case 31 having a substantially rectangular parallelepiped shape in a vertical direction in FIG. 3. Minimum width W33 in direction 40B is a width of connector portion 33A having a substantially cylindrical shape in the vertical direction in FIG. 3. Minimum width W33 of connector portion 33A is larger than minimum width W31 of case 31. Connector portion 33A is outside cavity 31D of case 31, and surface 33D is outside cavity 31D of case 31. This structure allows connector portion 33A to be larger than case 31, and allows the size of connector portion 33A to be changed without changing the design of case 31, thus allowing antenna device 40 to be connectable to a multiple vehicle connectors.

That is, making connector portion 33A larger than case 31 allows antenna device 40 of the embodiment to adapt a large connector portion 33A which cannot be accommodated in case 31, without changing the design of case 31.

A method of manufacturing antenna device 40 will be described below.

First, coil 2 is wound on an outer circumference of magnetic body 1 with an automatic winding machine. Next, insert magnetic body 1 having coil 2 wound thereon is inserted into recess 21A of terminal base 21 for assembling magnetic body 1 and terminal base 21 unitarily into antenna 30. Then, antenna 30 is inserted into cavity 31D of case 31 through opening 31A.

After inserting antenna 30 into case 31, a sealing material, such as silicone, is inserted into case 31 and hardened. This process allows case 31 accommodating antenna 30 therein to be easily carried and handled. Thus, antenna device 40 adaptable to multiple types of vehicle connectors is prepared.

Then, terminal insertion portion 34B of elastic sealer 34 is pushed into insertion hole 33C of sealing cap 33 for fixing, and then, elastic sealer 34 and sealing cap 33 is inserted through opening 31A into the case 31. At this moment, connection terminal 32 is pushed into terminal insertion portion 34B by squashing bump 34C, and insert portion 33B of sealing cap 33 is pushed entirely into case 31, thus completing antenna device 40.

Protrusion 34A is engaged with groove 31B. Therefore, insert portion 33B is prevented from moving back in cavity 31D of case 31 when insert portion 33B is pushed entirely into case 31.

Antenna 30 and elastic sealer 34 inserted into case 31 have constant sizes regardless of the size of a vehicle connector to which antenna device 40 is connected. Therefore, even when production quantity of antenna device 40 to be adapted to a particular vehicle connector is small, bulk production of antenna 40 is still possible as it may be adapted to varied vehicle connectors. Thus, production efficiency of antenna device 40 is enhanced.

Moreover, since the size of insert portion 33B is not affected by the size of connector portion 33A which is inserted into case 31, insert portion 33B can has the same size regardless of the size of the vehicle connector antenna to which antenna device 40 is connected, as well as case 31. Thus manufactured antenna device 40 is installed in a door handle of a vehicle for instance, and is connected to a controller installed in an instrument panel of the vehicle.

The vehicle connector attached to a cable of the controller is inserted into connector portion 33A of antenna device 40, thereby connecting the controller and antenna device 40 with connection terminal 32.

When a driver having a mobile transmitter-receiver approaches the vehicle, the transmitter-receiver starts communication with antenna device 40, and the controller unlocks the vehicle door. When the driver leaves the vehicle, the controller locks the door.

In above described, in connector portion 33A and insert portion 33B, a right surface of connector portion 33A and an outside surface of insert portion 33B crosses substantially perpendicularly to each other, and no part of connector portion 33A covers an outside surface of case 31, as is shown in FIG. 1. However, connector portion 33A may cover a part of the outside surface of case 31. This structure increases a path of water and moisture leading into case 31, effectively preventing water and moisture from seeping into cavity 31D of case 31.

FIG. 4 is a top view of another antenna device 140 according to Embodiment 1. In FIG. 4, components identical to those of antenna device 40 shown in FIGS. 1 to 3 are denoted by the same reference numerals. In antenna device 40 in FIGS. 1 to 3, connection terminal 32 electrically connected to antenna 30 is one piece terminal having no junction. Antenna device 140 in FIG. 4 includes connection terminal 42, sealing cap 43, and terminal base 44 instead of connection terminal 32, sealing cap 33, and terminal base 21 of antenna device 40 shown in FIGS. 1 to 3. Connection terminal 42 includes sealing-cap side connection terminal portion 42A inserted into sealing cap 43 and antenna side connection terminal portion 42B electrically connected to sealing-cap side connection terminal portion 42A. Antenna side connection terminal portion 42B is fixed to terminal base 44.

Sealing-cap side connection terminal portion 42A is insert-molded into sealing cap 43 and is fixed. Antenna side connection terminal portion 42B is also insert-molded into terminal base 44, a constituent member of the antenna and is fixed to terminal base 44.

A right end of sealing-cap side connection terminal portion 42A is joined to a left end of antenna side connection terminal portion 42B. Connecting plate 421B having a cross section having a substantially V-shape is attached to an end of antenna side connection terminal portion 42B. Connecting plate 421B covers the end of sealing-cap side connection terminal portion 42A and is swaged with the end, thereby causing plate 421B to fix sealing-cap side connection terminal portion 42A to antenna side connection terminal portion 42B.

In antenna device 140, mutually independent parts, i.e., antenna side connection terminal portion 42B and sealing-cap side connection terminal portion 42A are jointed. Therefore, even when sealing cap 43 is changed, it does not affect antenna side connection terminal portion 42B. Thus, antenna device 140 accommodating a common antenna unit is provided.

Connecting plate 421B simply joints sealing-cap side connection terminal portion 42A and antenna side connection terminal portion 42B without an extra work, such as soldering.

In above description, connecting plate 421B is attached to antenna side connection terminal portion 42B, but a connecting plate which is in a similar configuration to 421B may be attached to sealing-cap side connection terminal portion 42A.

As mentioned, according to the embodiment, sealing cap 33 includes connector portion 33A having one side opening and exposed from case 31 and insert portion 33B inserted into case 31. Connection terminals 32 electrically connected to antenna 30 penetrate sealing cap 33 toward opening 31A of case 31, and extend from inside bottom surface 33D of connector portion 33A. Minimum width W31 of case 31 is smaller than minimum width W33 of connector portion 33A. Accordingly, antenna device 40 flexibly adaptable to a variety of vehicle connectors is provided.

Insert portion 33B of sealing cap 33 has surface 33E inserted into case 31 and facing cavity 31D. Connector portion 33A of sealing cap 33 is exposed from case 31, and has surface 33D opposite to surface 33E. Connection terminal 32 passes from surface 33E of insert portion 33B through surface 33D of connector portion 33A, and extends from surface 33D in predetermined direction 40A. Minimum width W31 of case 31 in direction 40B perpendicular to direction 40A is smaller than minimum width W33 of connector portion 33A in direction 40B.

Connection terminal 42 shown in FIG. 4 includes sealing-cap side connection terminal portion 42A and antenna side connection terminal portion 42B electrically connected to sealing-cap side connection terminal portion 42A. In this case, sealing-cap side connection terminal portion 42A is insert-molded into sealing cap 43 to form one piece sealing cap 43. This arrangement allows antenna side connection terminal portion 42B to be short. Even if sealing cap 43 is changed, antenna side connection terminal portion 42B is not affected. Thus, antenna device 140 appropriately using a common antenna and a common elastic sealer is provided.

Antenna device 40 of Embodiment 1 has a small size integrating connector portion 33A. Antenna device 40 is flexibly adaptable to a change in the vehicle connector to be adapted.

### Exemplary Embodiment 2

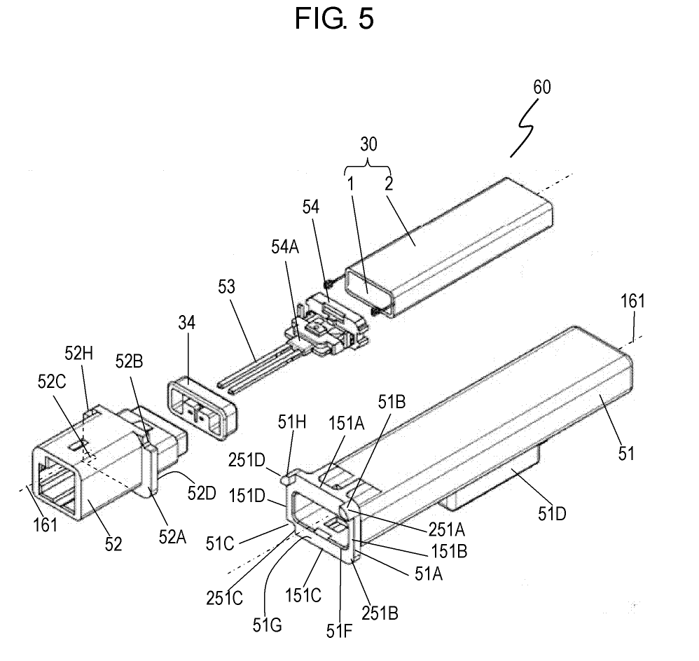

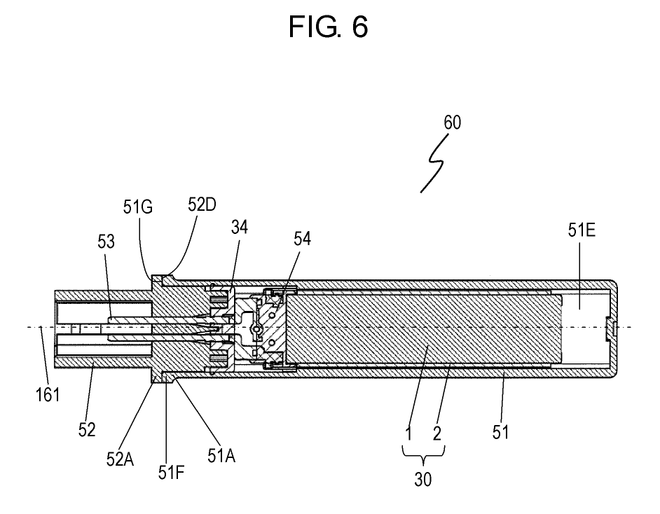

FIGS. 5 and 6 are an exploded perspective view and a cross sectional view of antenna device 60 according to Exemplary Embodiment 2 of the invention, respectively. In FIGS. 5 and 6, components identical to those of antenna device 40 shown in FIGS. 1 to 4 are denoted by the same reference numerals. Antenna device 60 according to Embodiment 2 includes case 51, sealing cap 52, connection terminal 53, and terminal base 54 instead of antenna device 40 including case 31, sealing cap 33, connection terminal 32, and terminal base 21.

Case 51 has cavity 51E and opening 51F similar to cavity 31D and opening 31A in case 31 of antenna device 40 according to Embodiment 1 shown in FIGS. 1 and 2. Case 51, sealing cap 52, and terminal base 54 are arranged along longitudinal axis 161. Sealing cap 52, terminal base 54, and antenna 30 are inserted through opening 51F into cavity 51E of case 51 and are accommodated in cavity 51E. Case 51 includes flat plate 51A provided at opening 51F of the case. Flat plate 51A has a substantially rectangular plate shape and extends toward sealing cap 52. Flat plate 51A has flat surface 51G facing sealing cap 52. Flat surface 51G has a substantially rectangular shape surrounded by four sides 151A to 151D. An end of side 151A meets an end of 151B at corner 251A. An end of side frame 151B meets an end of side frame 151C at corner 251B. An end of side frame 151C meets an end of side frame 151D at corner 251C. An end of side frame 151D meets an end of 151A at corner 251D. Corner 251D and 251B are adjacent to corner 251A. Corner 251B and 251D are adjacent to corner 251C. Corners 251A and 251C are opposite to each other. Corners 251B and 251D are opposite to each other. Protrusions 51B and 51H protrude from corners 251A and 251D of flat plate 51A toward sealing cap 52, respectively. A cross section of protrusion 51B and 51H has a shape of a quarter of an elliptic. Notch 51C having an elliptic arc shape is formed in corner 251C of flat plate 51A. Fixture 51D is attached to a lower surface of case 51 to be fixed to engaging fixture 35 shown in FIGS. 1 and 2. Coil 2 can be accommodated in case 51 even when case 51 is rotated about longitudinal axis 161 by 180 degrees.

Sealing cap 52 has flat plate 52A having a substantially rectangular plate shape. Flat plate 52A extends from the plate, and faces opening 51F of case 51. Flat plate 52 has flat surface 52D contacting flat surface 51G of flat plate 51A of case 51. Flat plate 52A has notch 52B and 52H formed in an elliptic arc shape fitting in protrusion 51B and 51H. Flat plate 52A has protrusion 52C protruding from surface 52D. Protrusion 52C is engaged with notch 51C of case 51.

Case 51 accommodates elastic sealer 34, terminal base 54, magnetic body 1, and coil 2, and is assembled with sealing cap 52 while protrusion 51B and 51H are engaged with notch 52B and 52H and notch 51C fitting in protrusion 52C. This structure allows case 51 to be appropriately assembled to prevent case 51 from being oriented upside down, and directs fixture 51D in a proper direction.

Each of Notches 51C, 52B and 52H may be a hole or a recess. One of respective surfaces of case 51 and sealing cap contacting each other has a protrusion which can be engaged with the notch, such that the protrusion does not have a further protrusion having a shape identical to the shape of the protrusion at a position which is rotationally symmetrical to the position of the protrusion and which matches the position of the protrusion when case 51 is rotated by 180 degrees about longitudinal axis 161.

Case 51 and sealing cap 52 are fixed with protrusion 51B, 51H and 52C correspondingly engaged with notch 52B, 52H and 51C. Case 51 is therefore prevented from rotating with respect to sealing cap 52, and is assembled in a proper position.

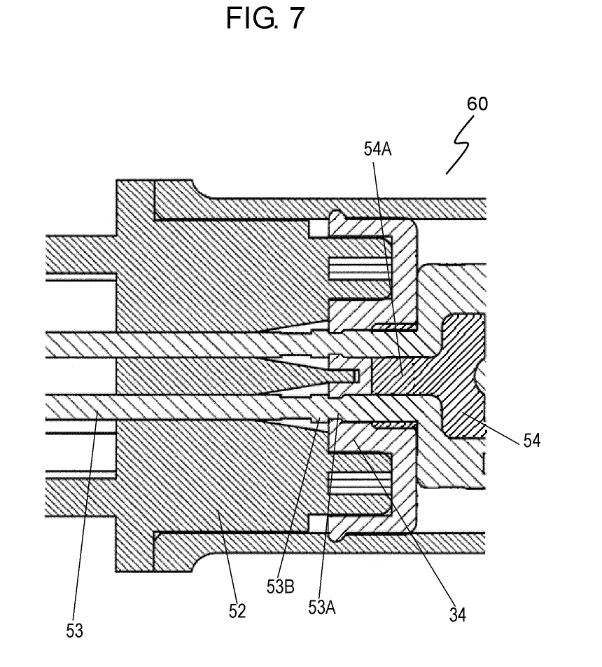

FIG. 7 is an enlarged sectional view of antenna device 60, particularly illustrating a portion where connection terminal 53 is inserted into sealing cap 52. Connection terminal 53 has notch 53A therein at a portion contacting elastic sealer 34. Notch 53A is provided in a left end surface of connection terminal 53 facing elastic sealer 34. Elastic sealer 34 is engaged with notch 53A at a left side of a position where elastic sealer 34 contacts connection terminal 53. This structure provides a left side of sealing cap 52 with a waterproof structure.

Terminal base 54 has insert portion 54A having a plate shape and protruding toward sealing cap 52. Insert portion 54A is inserted into elastic sealer 34, pressing elastic sealer 34 where insert portion 54A contacts elastic sealer 34. This structure provides the contact surface between elastic sealer 34 and insert portion 54A with another waterproof structure.

Connection terminal 53 has notch 53A where the terminal contacts elastic sealer 34 and also with protrusion 53B where the terminal 53 contacts elastic sealer 34, providing a water proof structure. Accordingly, antenna device 60 is provided with a suitable structure to be installed in a humid environment, such as an inside of a door handle of a vehicle.

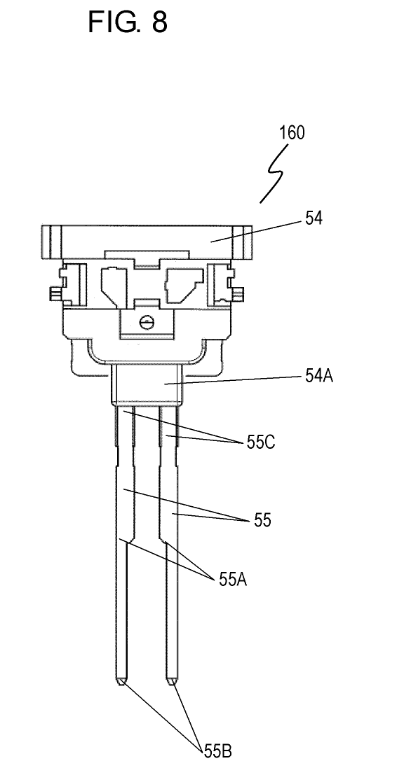

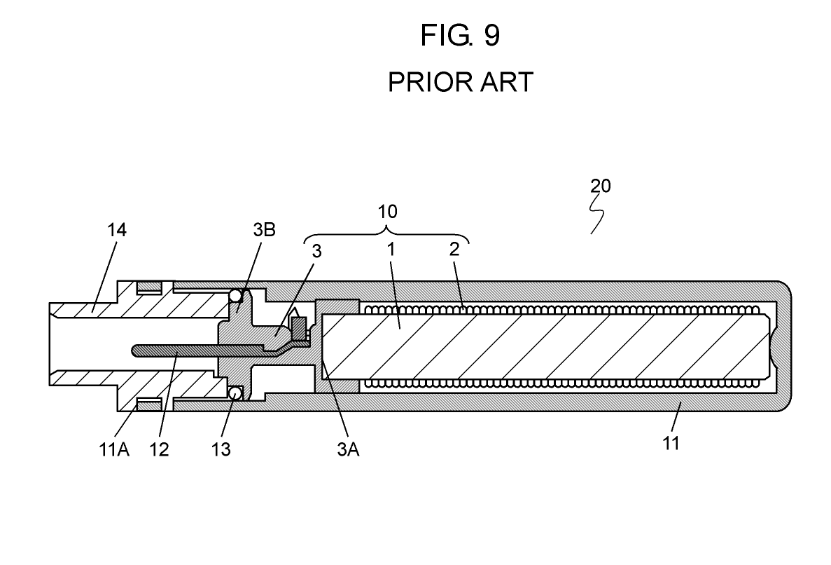

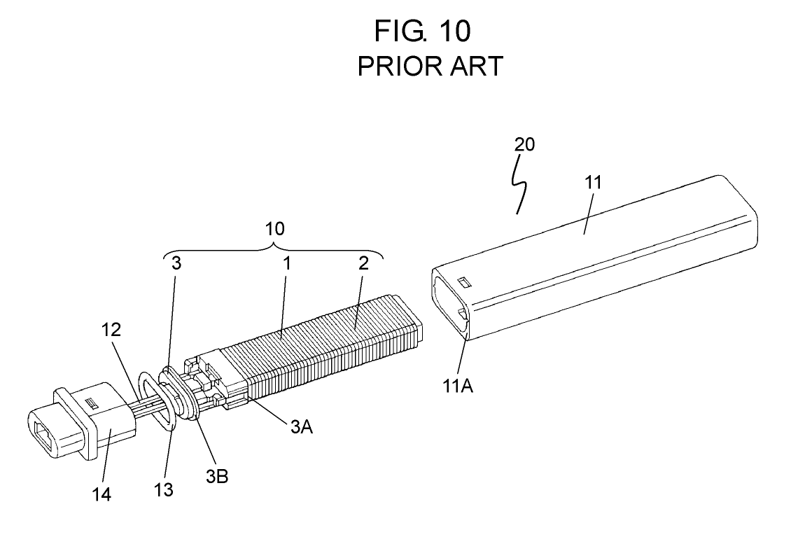

FIG. 8 is a top view of another antenna device 160 according to Embodiment 2. In FIG. 8, components identical to those of antenna device 60 shown in FIGS. 5 to 7 are denoted by the same reference numerals. Antenna device 160 shown in FIG. 8 includes connection terminal 55 instead of connection terminal 53 shown in FIGS. 5 to 7. Connection terminal 55 has tip 55B and root portion 55C connected to insert portion 54A of terminal base 54. Connection terminal 55 also includes step 55A. A portion of connection terminal 55 from step 55A to tip 55B is thinner than a portion of connection terminal 55 from step 55A to an end of root portion 55C. Step 55A allows connection terminal 55 to be adapted to a variety of vehicle connectors including connection terminals with different widths, enhancing manufacturing efficiency of the device.

In antenna device 60 shown in FIGS. 5 to 7, case 51 has protrusions 51B and 51H, and sealing cap 52 has one protrusion 52C. Antenna device 60 may only have at least one of protrusions 51B, 51H and 52C. Protrusion 51B and 51H is not necessarily be formed in a corner of rectangular flat surface 51G, but may be formed in a middle of one of sides 151A to 151D. Notch 52B is not necessarily formed in a corner of rectangular flat surface 52D and may be formed in a side of surface 52D.

Namely, according to Embodiment 2, a protrusion, such as protrusion 51B, 51H, or 52C, is formed to be engaged with at least on one of surfaces 51G and 52D where case 51 contacts sealing cap 52. The one of the surface does not have a further protrusion at a position which is rotationally symmetrical to the position of the one of protrusions 51G and 52D and which matches the position of the one of protrusions 51G and 52D when case 51 is rotated by 180 degrees. This structure prevents case 51 from rotating with respect to sealing cap 52 and is assembled in a proper direction.

Connection terminal 53 is fixed to terminal base 54 which includes insert portion 54A. Connection terminal 53 has notch 53A where the terminal contacts elastic sealer 34. Insert portion 54A is inserted into elastic sealer 34, pressing elastic sealer 34. Thus, two water proof structures: one where elastic sealer 34 contacts notch 53A; and another where insert portion 54A contacts elastic sealer 34, are established.

In antenna device 160 shown in FIG. 8, connection terminal 55 has step 5A, and the portion of connection terminal 55 from step 55A to the tip is thinner than the portion of connection terminal 55 from step 55A to another side, so that antenna device 160 is adaptable to a variety of vehicle connectors, enhancing manufacturing efficiency of the device.

As described, case 51 has flat surface 51G contacting sealing cap 52. Case 51 has protrusions 51B and 51H protruding from flat surface 51G and engaged with sealing cap 52. Case 51 does not have a protrusion having a shape identical to the shape of protrusion 51B or 51H at a position which is rotationally symmetrical to the position of protrusion 51B or 51H and which matches the position of protrusion 51B or 51H when case 51 is rotated by 180 degrees with reference to sealing cap 52 about longitudinal axis 161.

Sealing cap 52 has flat surface 52D contacting flat surface 51G of case 51. Sealing cap 52 has protrusion 52C protruding from surface 52D and engaged with case 51. Sealing cap 52 does not have a further protrusion having a shape identical to the shape of protrusion 52C at a position which is rotationally symmetrical to protrusion 52C and which is matches the position of protrusion 52C when case 51 is rotated by 180 degrees with reference to sealing cap 52 about longitudinal axis 161.

Elastic sealer 34 is disposed between sealing cap 52 and case 51, and seals opening 51F of case 51. Terminal base 54 has insert portion 54A inserted into elastic sealer 34. Connection terminal 53 is fixed to terminal base 54 and the connection terminal has notch 53A at a portion where it contacts elastic sealer 34. Insert portion 54A presses elastic sealer 34.

Connection terminal 55 has tip 55B and step 55A. A portion of connection terminal 55 from step 55A to tip 55B is thinner than a portion of connection terminal 55 from step 55A toward antenna 30.

What is claimed is:

1. An antenna device comprising:
an antenna;
a case having an opening and a cavity communicating with the opening, the cavity accommodating the antenna therein;
a sealing cap partially inserted into the case through the opening of the case; and
a connection terminal electrically connected to the antenna and extending from the antenna in a predetermined direction, wherein
the sealing cap includes:
an insert portion inserted into the case, the insert portion having a first surface facing the cavity; and
a connector portion exposed from the case, the connector portion having a second surface opposite to the first surface,
the connection terminal penetrates from the first surface of the insert portion through the second surface of the connector portion and extending from the second surface in the predetermined direction,
a minimum width of the case in a direction perpendicular to the predetermined direction is smaller than a minimum width of the connector portion in a direction perpendicular to the predetermined direction.

2. The antenna device as defined in claim 1, wherein
the connection terminal is includes:
an antenna side connection terminal portion extending from the antenna; and
a sealing-cap side connection terminal portion penetrating from the antenna side connection terminal portion through the sealing cap,
the sealing-cap side connection terminal portion is insert-molded into the sealing cap for molding the sealing cap.

3. The antenna device as defined in claim 1, wherein the connector portion includes:
a sleeve extending in the predetermined direction and surrounding the connection terminal; and
a bottom having the second surface and closing the sleeve.

4. The antenna device as defined in claim 1, wherein
the case has a surface contacting the sealing cap,
the case has a first protrusion protruding from the surface of the case and being engaged with the sealing cap, and
the case does not have a further protrusion having a shape identical to a shape of the first protrusion at a position which is rotationally symmetrical to a position of the first protrusion and which matches the position of the first protrusion when the case is rotated 180 degrees with respect to the sealing cap.

5. The antenna device as defined in claim 4, wherein
the sealing cap has a surface contacting the surface of the case,
the sealing cap has a second protrusion protruding from the surface of the sealing cap and being engaged with the case,
the sealing cap does not have a further protrusion having a shape identical to a shape of the second protrusion at a position which is rotationally symmetrical to a position of the second protrusion and which matches the position of the second protrusion when the sealing cap is rotated 180 degrees with respect to the case.

6. The antenna device as defined in claim 1, wherein
the sealing cap has a surface contacting the case,
the sealing cap has a protrusion protruding from the surface of the sealing cap and being engaged with the case,
the sealing cap does not have a further protrusion having a shape identical to a shape of the protrusion at a position which is rotationally symmetrical to a position of the protrusion and which matches the position of the protrusion when the sealing cap is rotated 180 degrees with respect to the case.

7. The antenna device as defined in claim 1, further comprising:
an elastic sealer disposed between the sealing cap and the case and sealing the opening of the case; and
a terminal base having an insert portion inserted into the elastic sealer, wherein
the connection terminal is fixed to the terminal base and has a notch formed in a position contacting the elastic sealer, and
the insert portion presses the elastic sealer.

8. The antenna device as defined in claim 1, wherein
the connection terminal has a tip and a step, and
a portion of the connection terminal from the step to the tip is thinner than a portion of the connection terminal from the step to the antenna.
